(19) United States
(12) Patent Application Publication
(10) Pub. No.: US 2025/0265600 A1
(43) Pub. Date: Aug. 21, 2025

(54) AUTHENTICATION OF ASSETS USING PHYSICAL TOKENS AND DIGITAL TWINS

(71) Applicant: Counterpart Holdings, LLC, Chicago, IL (US)

(72) Inventors: Andrew J. Birnbaum, Washington, DC (US); Lee Michael Wolf, Chicago, IL (US)

(21) Appl. No.: 18/857,717

(22) PCT Filed: Apr. 19, 2023
(86) PCT No.: PCT/US2023/065946

§ 371 Date: Oct. 17, 2024

Related U.S. Application Data
(60) Provisional application No. 63/332,524, filed on Apr. 19, 2022.

(51) Int. Cl. G06Q 30/018; G06T 7/00

(52) U.S. Cl. CPC G06Q 30/018; G06T 7/0002; G06Q 2220/00

(57) ABSTRACT

Methods, systems, and devices for authenticating a physical object are provided. A base of the physical object is identified. The base is characterized. A digital format of a reference based is retrieved from a data structure. The data structure further includes a target asset identifier uniquely identifying a target asset. The digital format of the reference base is compared with the characterized base. The physical object is authenticated as being the target asset based on the comparison and the target asset identifier.

### TECHNICAL FIELD

This disclosure relates to producing physical objects manifesting unique characteristics, whereby these the unique characteristics are encoded digitally, and the physical-digital couple may be used to authenticate a distinct physical or digital asset.

### BACKGROUND

Present anti-counterfeiting techniques and systems suffer from a variety of drawbacks, limitations, and disadvantages. Accordingly, there is a need for inventive systems, methods, components, and apparatuses described herein.

### BRIEF DESCRIPTION OF THE DRAWINGS

The embodiments may be better understood with respect to the following drawings and description. The components in the figures are not necessarily to scale. Moreover, in the figures, like-referenced numerals designate corresponding parts throughout the different views.

FIG. 1A illustrates an example two-dimensional depiction of a polycrystalline microstructure in accordance with the present subject matter.

FIG. 1B illustrates example overview of the relationships between various components and processes to be described in accordance with the present subject matter.

FIG. 2A illustrates a flow diagram of an example process to manufacture a base in accordance with the present subject matter.

FIG. 2B illustrates an example of a liquid suspension technique for creating a base in accordance with the present subject matter.

FIG. 2C illustrates an example of laser polishing to reveal a microstructure of a crystalline material in accordance with the present subject matter.

FIG. 2D illustrates an example of etching to reveal a microstructure of a crystalline material in accordance with the present subject matter.

FIG. 3 illustrates a flow diagram of an example process to characterize a base using optical techniques in accordance with the present subject matter.

FIG. 4 illustrates an example of characterization and encoding using electron backscatter diffraction techniques in accordance with the present subject matter.

FIG. 5 illustrates examples of packaging and integrating the base with various target assets in accordance with the present subject matter.

FIG. 6 illustrates an example authentication process in accordance with the present subject matter.

FIG. 7 illustrates a flowchart for an image matching algorithm in accordance with the present subject matter.

FIG. 8A illustrates an example block diagram overview of a blockchain network in accordance with the present subject matter.

FIG. 8B illustrates an example block of the blockchain in accordance with the present subject matter.

FIG. 9 illustrates a flowchart for a process in accordance with the present subject matter.

FIG. 10 illustrates a computing device in accordance with the present subject matter.

### DETAILED DESCRIPTION

According to the present subject matter, a method of characterizing a microstructure of at least a portion of a material, termed a “base,” is provided. The method may include characterizing a microstructure of the base using microscopy or other techniques, wherein the characterized microstructure may include one or more features including phase boundaries, grain boundaries, amorphous inclusions, crystalline inclusions, precipitates, compounds, impurities, slip traces, slip bands, slip lines, persistent slip bands, defect structures, dislocation, stacking faults, or cold work. The method may further include encoding the one or more features into an n-dimensional digital format. The method may further include storing the n-dimensional digital format in a non-transitory computer-readable memory.

According to the present subject matter, a method of authenticating a physical object is provided. The method may include identifying a base of the physical object, characterizing the base, and retrieving a digital format of a reference base specified in a data structure. The data structure may further include a target asset identifier uniquely identifying a target asset. The method may further include comparing the digital format of the reference base with the characterized base. The method may further include authenticating the physical object as being the target asset based on the comparing and the target asset identifier.

The present subject matter provides methods for the manufacture, packaging, integration, encoding, and authentication of digitally-validated physical objects. The approaches presented herein may leverage the information content embedded naturally in the vast majority of metallic materials as well as many inorganic, crystalline materials, such as ceramics and semiconductors.

The term “alloy” as used herein refers to any mixture of two or more elemental metals.

The term “crystal” as used herein refers to a collection of atoms arranged in a periodic space in two and/or three dimensions. The periodic space between atoms is referred to as a lattice constant. Additionally, depending on the crystal structure, multiple distinct lattice constants may be necessary for its full description.

The term “polycrystalline” as used herein refers to a material having or being composed of multiple distinct crystalline regions or volumes.

The term “grain” as used herein refers to an individual crystal.

The term “grain boundary” as used herein refers to a boundary surface (in three dimensions) or boundary segment (in two dimensions) separating adjacent grains in a polycrystalline material. Grain boundaries may exist as interfaces that separate adjacent grains that are rotated relative to one another in two or three-dimensional space. These relative rotations may also be termed respective orientations.

The term “microstructure” as used herein refers to the grains, grain boundaries, phase boundaries, defects, inclusions, impurities, and possibly other characteristics of a material, such as a metal or alloy of metallic elements. The microstructure of a given sample of a metal or alloy is unique in the universe, such that it is impossible to find a duplicate microstructure. Furthermore, no known technology is capable of synthesizing or manufacturing a metal sample having a duplicate microstructure.

The term “phase” as used herein refers to a region or volume of material having a crystal structure, local composition, and/or atomic bonding configuration that is uniform.

The term “phase boundary” as used herein refers to a boundary surface separating distinct phases of material within a polycrystalline material. Phase boundaries result when local or global material system energetics (both thermodynamic and/or kinetic) are minimized via the formation of distinct phase regions. Phase boundaries separate these regions.

All pure metals, and nearly all alloys may be composed of large aggregates of grains. The formation of grains and grain boundaries is a natural process that may occur upon solidification of metals from a molten state. In accordance with the present subject matter, the uniqueness of a metal's microstructure may be useful or interesting as a form of physical authentication.

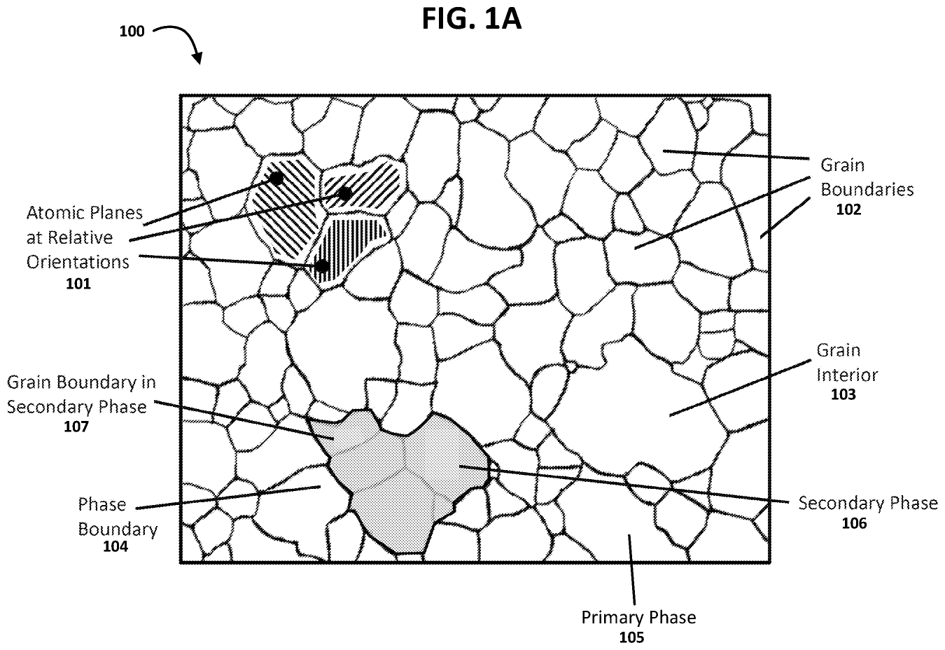

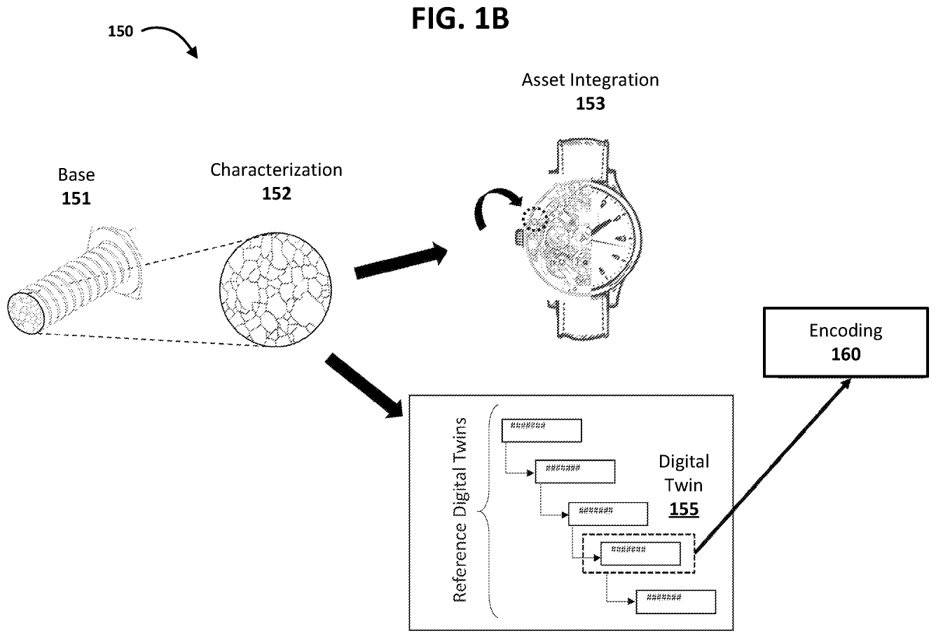

FIG. 1A illustrates an example two-dimensional depiction of a polycrystalline microstructure 100. Though many of the references described herein refer to metallic materials, the descriptions given are equally applicable to any inorganic crystalline material such as ceramics or semiconductors. The polycrystalline microstructure 100 may exhibit atomic planes of relative orientations 101, grains defined by grain boundaries 102 and grain interiors 103, and phase boundaries 104 between grains of different phases including for example, primary phase 105, and at least secondary phase 106. Grain boundaries 102 may exist both between grains of the primary phase and the secondary phase, respectively; e.g., 102 and 107.

The microstructure 100 of a metal may be qualitatively or quantitatively characterized (e.g., imaged, orientations determined, composition ascertained, etc.) by several different techniques of varying sophistication and cost. Upon characterizing a metal sample's microstructure and translating it into a digital format, an inextricably linked, direct digital instantiation of a physical object, termed a “digital twin,” may be created. The digital format may be n-dimensional, where n is 1 or greater. Alternatively, or in addition, the “digital twin” may be the result of the characterization step 152 followed by one or more secondary derivations, such as to encode 160 the characterization 152 into a further image, text file, serial number, sound, or any other data format. As will be subsequently discussed, the physical object may be utilized to authenticate the physical object itself or a separate and distinct physical/digital object. In this way, the physical object is referred to as a physical authentication object or a “base” as used herein.

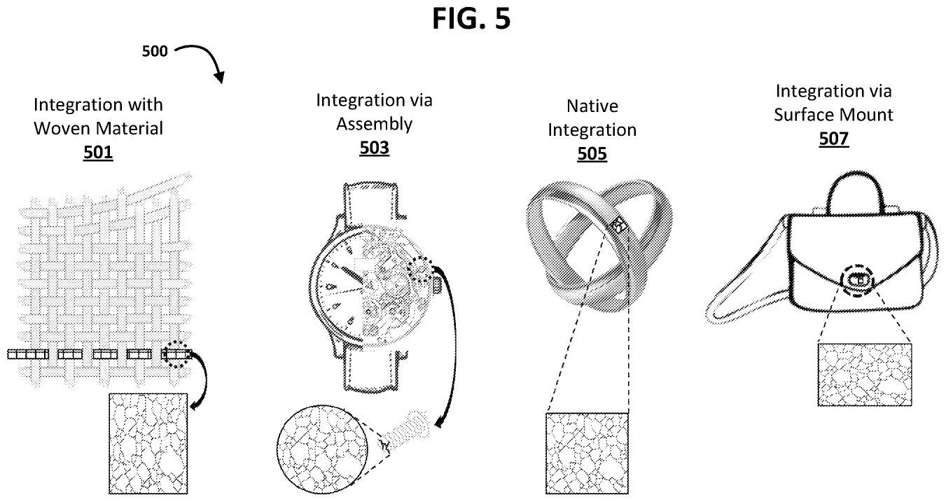

FIG. 1B provides an example overview 150 of the relationships between various components and processes of the present subject matter to be discussed herein. The base 151 may take the form of a sample of a metal or alloy and may be used to create the digital twin 155, which may be a digital encoding 160 of the characterization 152 of the base 151. The digital twin 155 may be stored on a distributed ledger such as a blockchain, one or more servers, or any other computing device capable of storing data. The digital twin 155 may serve to authenticate either the base 151 itself, a separate and distinct target asset into which the base 151 has been integrated, and/or a digital asset to which the base 151 has been linked (e.g., in a database). The authentication process may be either fully automated, partially automated (human-in-the-loop), or fully manual and performed solely by an individual. The geometry and physical form factor of the base 151 may be tailored for integration depending on the asset type, and may be made exceedingly small (<1 mm). For instance, the base 151 may be formed from a metallic thread sewn into a garment, a rivet or other fastener incorporated into a handbag, or may largely embody the target asset itself, such as gold jewelry, for example. Alternatively, or in addition, the base 151 may be imprinted, etched, embossed, and/or milled with a scannable UPC or QR code. Alternatively, the base 151 may be cut and/or shaped as a plurality of pieces that form a scannable UPC or QR code. The characterized base 151 may be integrated 153 with an asset, as will be subsequently described with respect to FIG. 5.

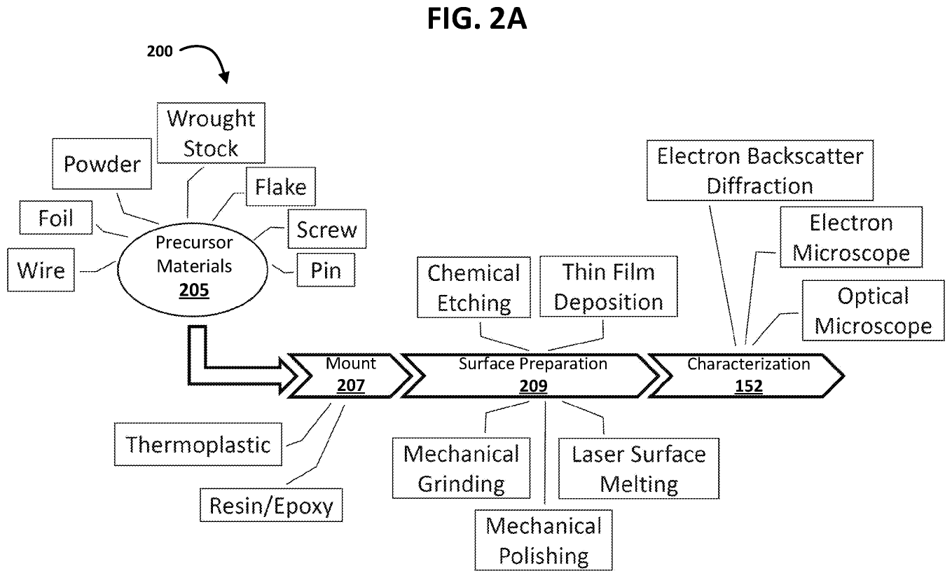

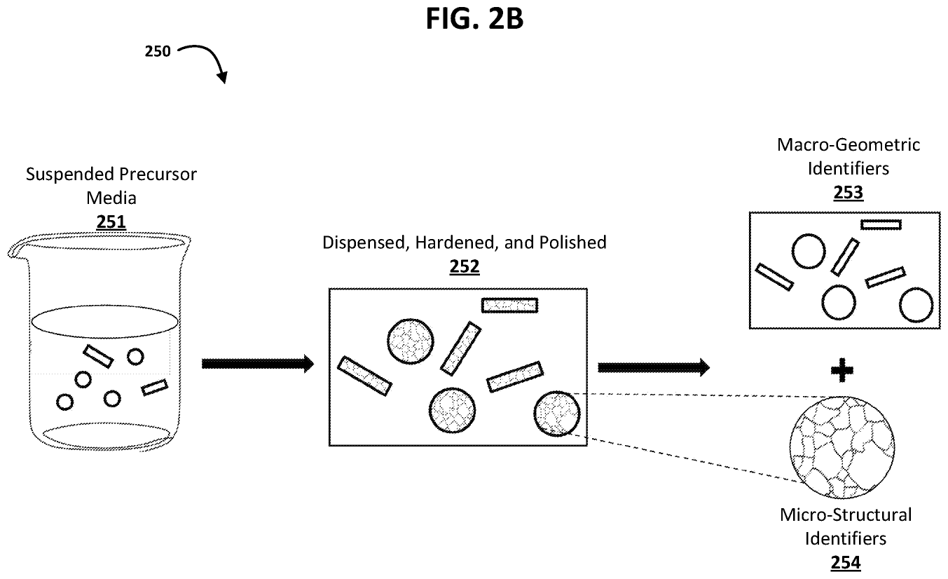

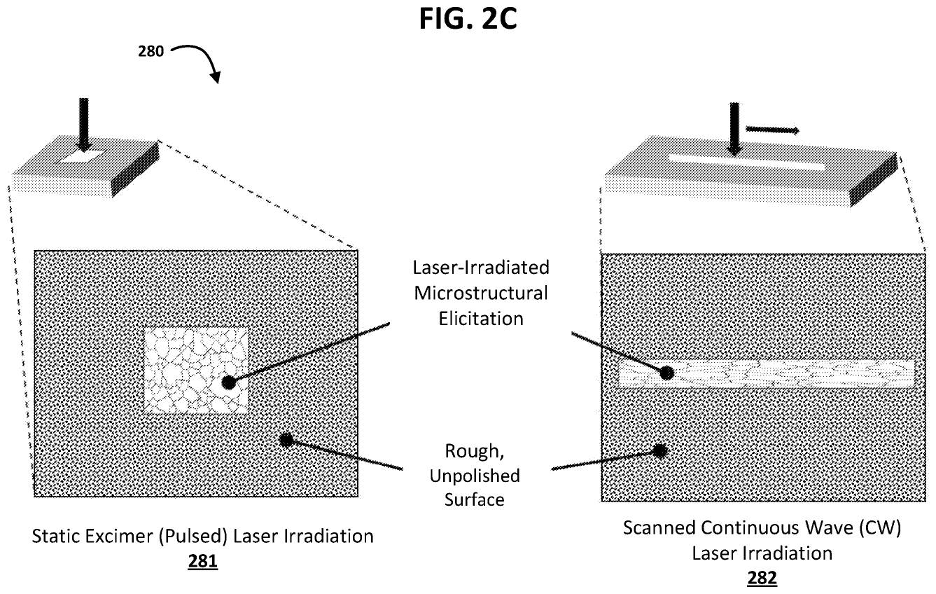

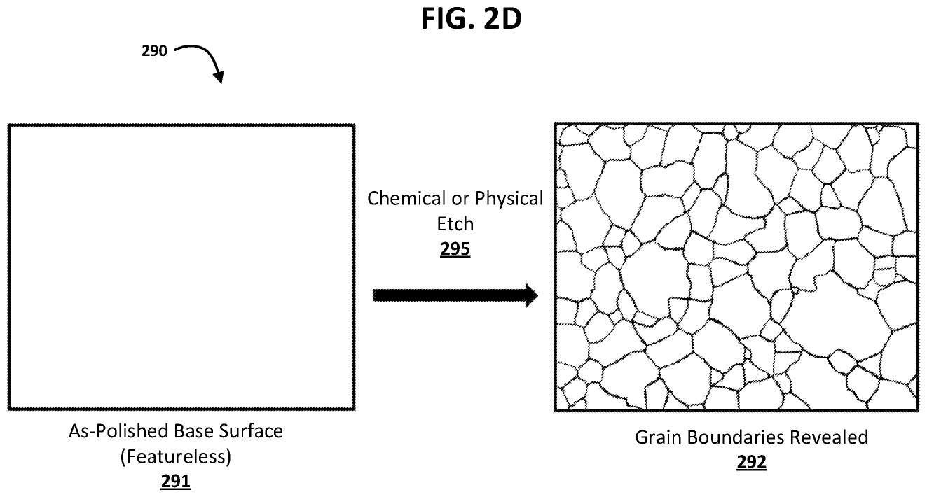

FIG. 2A is a flow diagram showing an example process 200 to manufacture a base 151, which may include the steps of mounting 207 the base 151, preparing the surface 209 of the base 151, and characterizing 152 the base 151. The base(s) 151 may be manufactured from selected source materials, termed “precursor materials.” A precursor material 205 may possess a unique microstructure 100 that may be ascertained via a variety of techniques in accordance with the present subject matter. The precursor materials 205 to be utilized in the production of the base 151 may include any pure metal and/or, alloy, including any mixture or combination of metals, semi-metals, semiconductors, insulators, and/or any combination thereof.

The precursor material 205 may be manufactured from a suitable pure material or alloy composed of multiple phases (in solid-state, i.e., below its melting temperature) such that information describing the nature of the phase boundaries 104, phase content, and/or the orientation of grains within disparate phase regions may be determined using an appropriate characterization technique 152 and stored on a memory device in a digital format. The features of the phase boundaries 104 that may be determined may include one or more of: phase boundary geometry (the position of infinitesimal boundary segments in two or three-dimensional space), curvature, length, fractal dimensionality, and/or any other characterizable topological/geometric descriptor. The features of the phase content being determined may include one or more of to: relative proportion of phases present in the characterized region (i.e., phase area or volume fraction of respective phases), absolute area of respective phase regions, centers of mass of respective phase regions in two or three dimensions, relative positions of centers of mass of distinct phase regions (i.e., relative vector positions), and/or any characterizable topological/geometric descriptor. The features of the grain orientations within respective phase regions being determined may include one or more of: local orientation within a grain, average orientation of a grain, average orientation of a collection of grains within a respective phase region, and/or relative average orientations of collections of grains within disparate phase regions.

Alternatively, or in addition, the precursor material 205 may be manufactured from a suitable pure metal or alloy manifesting a polycrystalline microstructure 100 such that the features of the grains and/or nature of the grain boundaries 102 may be determined using an appropriate characterization technique 152, and stored on a memory device in a digital format. The features of the grains being determined may include one or more of: absolute areas of respective grains, centers of mass of respective grains in two or three dimensions, relative positions of centers of mass of distinct grains (i.e., relative vector positions) and/or any characterizable topological/geometric descriptor. The features of the grain boundaries 102 being determined may include one or more of: grain boundary geometry (the position of infinitesimal boundary segments in two or three-dimensional space), curvature, length, fractal dimensionality, triple points, and/or any characterizable topological/geometric descriptor.

Though adjacent grains can exhibit the same crystal structure, their respective crystal structures may be rotated relative to an absolute coordinate frame and defined by the method of characterization in two or three-dimensional space. This rotation is referred to as a grain's respective “orientation.” A grain's orientation may be described mathematically using several distinct, but equivalent descriptions including a set of Euler Angles, Rodriguez Vectors, quaternions, or angle-axis definitions. The features of a grain's orientation that may be determined include one or more of: spatially-resolved local orientation, average (individual) grain orientation, and/or aggregate (multi-grain) average orientation.

Alternatively, or in addition, the respective crystal structures of adjacent grains may be rotated relative to a coordinate frame defined by another adjacent or non-adjacent grain. This relative rotation is referred to as a grain's “misorientation,” and may be described mathematically as \tilde{G}_{b}=Δ\tilde{G}_{ab}\tilde{G}ₐ, where \tilde{G}ₐ and \tilde{G}_{b} may be the direction cosine matrices of the orientations in respective grains, and Δ\tilde{G}_{ab} transformation matrix which brings the coordinate frame a into coincidence with b. The features of a grain's misorientation that may be determined include one or more of: spatially-resolved local misorientation with respect to an adjacent grain, misorientation with respect to a non-adjacent grain, kernel average misorientation, and/or grain average misorientation. Alternative descriptions of misorientation in terms of quaternions, rodriguez vectors or axis-angle combinations may also be utilized.

A precursor material 205 may be manufactured from a suitable pure metal or alloy manifesting a polycrystalline microstructure 100 and having a surface that is purposely deformed (e.g., stretched, compressed, torqued, indented upon, fatigued, or some combination thereof) such that deformation-induced defect structures are generated on the precursor material's surface and are readily characterizable via the use of a suitable technique, and stored on a memory device in a digital format. In this case, the surface of the precursor material 205 may not be treated with any post-surface flattening technique as will be subsequently described such that the surface appears otherwise optically featureless. Alternatively, the surface of the precursor material 205 may be treated with post-surface flattening techniques as will be subsequently discussed such that the deformation features produced may be simultaneously characterized 152 along with other microstructural features. The features of the defect structures that may be determined may include one or more of: slip trace position(s) on the precursor material surface, slip band position(s) on the precursor material surface, persistent slip band position(s) on the precursor material surface, indentation induced surface deformation, and/or embossing. The features of defect structures that may be determined simultaneously with other microstructural feature(s) may include one or more of: slip trace position(s), spatial frequencies, and/or angles on the base's surface, slip band position(s), spatial frequencies, and/or angles on the base's surface, persistent slip band position(s), spatial frequencies, and/or angles on the base's surface, indentation induced surface deformation, and/or embossing.

The precursor materials 205 may exhibit a range of geometries and form factors including, for example, foils, flat sheets, plates, blocks, dowels, rods, pins, cylinders, screws (threaded), wire, shot, ball-bearings, powders, flakes, fibers, whiskers, chips, and/or any combination thereof.

The processing history of the precursor material 205 (e.g., cast, forged, etc.) may have a dramatic effect on the nature of the unique microstructural characteristics to be exploited in accordance with the present subject matter. The precursor materials 205 to be utilized may have been previously subjected to a wide range of processes including, for example, drawing, rolling, casting, annealing, punching, cold working, sintering, gas atomization, metal injection molding, swaging, forging, laser powder bed fusion, welding, direct energy deposition, peening, and/or any combination thereof.

The resulting precursor material microstructure 100 may exhibit a range of morphological characteristics, for example, equiaxed, elongated, cellular, cellular-dendritic, dendritic, additively manufactured, globular, skeletal, or any combination thereof. The crystallographic orientation of the precursor material 205 may be random or have a texture (preferred crystallographic orientation) component.

Following selection of the precursor material(s) 205, the precursor material 205 may be subsequently mounted to a mounting structure 207. The precursor material 205 may be initially embedded into a suitable mounting material and/or mounting structure such that the precursor material 205 to become the base may be processed and prepared for subsequent characterization 152. Preferably, multiple monolithic precursor materials 205 may be made from the same or disparate metals. The multiple precursor materials 205 may also be non-monolithic and may take the form of metallic powder particles, fibers, strands of wire, or the like, for example.

In the case of one or more non-monolithic precursor materials 205, the precursor material(s) 205 may be processed in accordance with the overview process 250 depicted in FIG. 2B. As an initial step, the precursor materials 205 (i.e., media) may be suspended in a liquid mounting material 251, such as a hardened two-part epoxy resin, for example, which may allow the precursor material(s) 205 may be processed simultaneously in an expedient fashion. This suspension of the precursor media 251 may be provided via a suitable method (e.g., syringe, dropper, extrusion nozzle) to apply epoxy resin directly onto a target object surface and then hardened in place via the addition of the hardener component of a two-part epoxy system. The base may then be processed, characterized 152, and encoded 160 in-place. Alternatively, or in addition, the epoxy resin may be dispensed onto a temporary mount and then hardened via the addition the hardening component of the two-part epoxy system allowing for processing to flatten the surface (i.e., dispensed, hardened, and processed 252). Following flattening, the macro-geometric identifiers 253 and/or microstructural identifiers 254 of the surface may be characterized 152 and encoded 160 of prior to removal from the temporary mount and final integration with the target asset.

The object in which the base 151 is specified (the “base object”) may be a designated surface of a functional or structural object (e.g., a screw, rivet, nail, or the like) such that it serves a dual function as an authentication object as well as performing some function, such as joining two disparate components of a target asset or product. An example dual-function base may be the head of a fine screw that is used to assemble a watch.

The base object may take the form factor of a wire or fine fiber such that it can be integrated into cloth, fabric, paint canvas, and/or any other woven target object.

A collection of base objects (e.g., multiple powder particles, glitter, sand, lengths of wire, flakes, chips, etc.) may be directly integrated into a material that is initially liquid, which subsequently hardens, dries, or cures (e.g., paint, thermoplastic polymers, thermoset polymers, or the like). Alternatively, or in addition, a collection of base objects (e.g., multiple powder particles, lengths of wire, flakes, chips, etc.) of disparate materials such as steel and bronze may be prepared as previously described and such that the microstructure 100 of one of the materials is visible, while the other remains optically invisible. This may allow for partitioning of the characterizable features that may be accessed via optical techniques, while the remaining features may be characterized 152 via either scanning electron microscopy and/or EBSD.

The precursor material(s) 205 may be subjected to a series of surface preparation 209 steps, such as mechanical grinding and/or polishing with progressively finer media to achieve suitable flatness for surface characterization 152. Alternatively, or in addition, the surface of the precursor material 205 may be scanned and/or subjected to laser polishing 280 such that the surface of the material temporarily melts and then solidifies. In this way, the laser-processed portion of the surface is sufficiently flat/smooth for subsequent characterization 152, as shown in FIG. 2C. Use of “laser polishing” 280 to enable metallographic/microstructural inspection and characterization 152 may preclude the need for mechanical processing/polishing, thus significantly simplifying and shortening the time required for surface preparation 209.

One specific example of laser polishing 280 is via the utilization of a pulsed excimer laser 281. This approach may be particularly well suited for microstructural inspection, as, due to its operational characteristics, an excimer laser is capable of providing a significant level of pulsed power over a relatively large area (˜1 mm²) with a uniform (spatial) energy density (J/mm²). The irradiation process essentially involves one-dimensional heat transfer into the base allowing for melt and subsequent resolidification to preserve the original microstructure 100 while imparting an extremely smooth surface because of surface tension while molten, which may be beneficial. Another example of laser polishing 280 may be stationary continuous wave (CW) laser irradiation 282, which provides a near uniform or non-uniform (e.g. gaussian) energy distribution within the laser spot.

Another example may combine laser polishing 280 and base serialization in a simultaneous processing step. A CW laser 282 may be scanned over the base surface using the requisite processing parameters (i.e., laser power, scan velocity and spot size) for achieving local melting and re-solidification. However, instead of a simple linear trajectory, the laser may be controlled such that it traces out a serial number. This serial number can to be used for subsequent base identification in addition to the local microstructure 100 being altered (within the scanned regions tracing out the identification pattern), which may allow for a unique authentication purposes.

Following preparation of the precursor material surface, the precursor material 205 may be exposed to one or more liquid acid or base chemicals; one or more vapor or gas chemicals; one or more forms of plasma processing, such as sputtering, ion milling, reactive ion etching, deep reactive ion etching, and/or the like; one or more layers of film may be deposited onto the surface of the precursor material 205 using techniques such as sputter deposition, chemical vapor deposition, thermal evaporation, electron-beam evaporation, ion-beam deposition, or liquid-based surface precipitation, such that the microstructure 100 of the precursor material 205 is revealed 292 and allows the surface to be characterized 152. FIG. 2D shows an example of using a chemical or physical etch 295 to convert a polished base surface 291 exhibiting no characteristic features to a characterizable surface having grain boundaries 102 revealed 292. Any of the aforementioned techniques may be included or omitted in the overall process of preparing the precursor material 205 to expose and/or conceal specific characteristics of the precursor material microstructure 100 as desired, thus providing a form of physical encryption. For instance, concealing specific characteristics of the microstructure 100 may be understood as a form of physical encryption. In an example, a surface may be deliberately not etched such that the features are not visible if viewed under an optical microscope, but observable using electron backscatter diffraction (EBSD). In this way, a malicious actor that wrongfully obtains the target asset and/or the base 151 could not observe the microstructure 100 using an optical microscope or otherwise characterize 152 the base 151 without using costly EBSD equipment. Alternatively, or in addition, the base 151 may be etched, characterized 152, and/or encoded 160, and then a film may be deposited to obscure the microstructure 100 of the base 151. Only a subsequent careful removal of the film may allow visualization of the microstructure 100 and authentication to proceed.

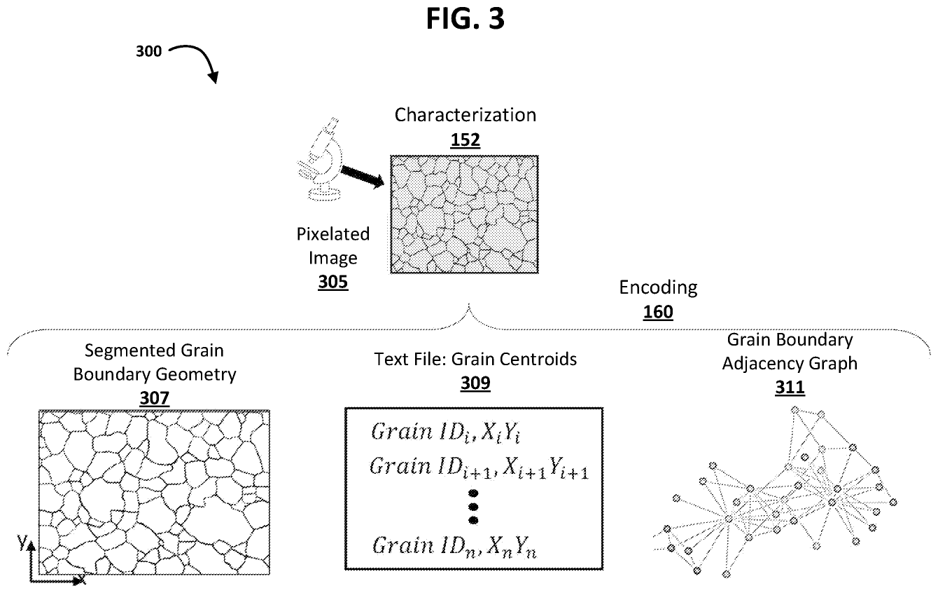

FIG. 3 illustrates a flow diagram of an example process 300 to characterize 152 a base 151 using optical techniques. The example process 300 may be used to characterize 152 the processed precursor material 205, which is now termed a “base” 151 as previously described. The example process 300 may be used to characterize unique features, specifically the microstructure 100, of the base 151, and may characterize 152 the unique features simultaneously, sequentially, or some combination thereof. Characterization 152 may be defined by the active or passive production, assessment (processing or lack thereof), and recording of feature(s), aspect(s), component(s), property (ies), response(s) due to active or passive interactions and/or interrogations of the base 151 with or without a stimulus. Characterization 152 may be performed over one or more points, areas, and/or volumes in two or three-dimensional space.

As shown in FIG. 3, characterization 152 may be performed utilizing optical techniques that occur within the visible portion of the electromagnetic spectrum. These optical techniques may include one or more of: reflected light optical microscopy, transmitted light optical microscopy, bright-field optical microscopy, dark-field optical microscopy, fluorescence microscopy, polarized-light microscopy, differential interference contrast microscopy, and/or polarized-light microscopy with sensitive tint.

Alternatively, or in addition, characterization 152 may be performed utilizing techniques relying on the interrogation/interaction of materials with portions of the electromagnetic spectrum that are not in the visible range. These non-visible techniques may include one or more of: x-ray diffraction, raman spectroscopy, infrared, and/or ultraviolet spectroscopy.

Alternatively, or in addition, characterization 152 may be performed using beam-based techniques employing, for example, an electron beam, ion beam and/or laser beam. These beam-based techniques may include one or more of: scanning electron microscopy (secondary and/or backscattered), electron backscatter diffraction (EBSD), transmission electron microscopy, selected area diffraction, electron dispersive x-ray spectroscopy, and/or x-ray photoelectron spectroscopy.

Alternatively, or in addition, characterization 152 may be performed using direct surface interrogation techniques. These direct surface interrogation techniques may include one or more of: atomic force microscopy, scanning tunneling microscopy, and/or micro or nanoindentation.

The characterization techniques 152 previously described may reveal various unique features and aspects of the base's microstructure 100. These microstructural features may include: phase boundaries 104, grain boundaries 102, amorphous inclusions, crystalline inclusions, precipitates, compounds (e.g., inter-metallics), impurities (purposely distributed, or incidental), slip traces, slip bands, slip lines, persistent slip bands, defect structures, dislocations, stacking faults, and/or cold work. The grain boundaries 102, phase boundaries 104, defects, and the like may then be encoded and stored digitally as a two-dimensional (pixelated) image 305. A variety of encoding techniques 160 may be used. For instance, based on their gray-scale value, grain boundaries 102 may be identified and segmented 307 such that they are differentiated from grain areas. This may enable the extraction of information regarding the spatial connectivity of grains and their adjacent neighbors. This adjacency information may be encoded as a weighted or unweighted mathematical graph structure 311 where nodes may correspond to grains, edges may correspond to their being connected spatially through a shared grain boundary 102, with or without weights corresponding to one or more features including: length of grain boundary 102 separating respective grains, curvature of grain boundary 102 separating respective grains, and/or a ratio of areas of respective grains. The weighted and/or unweighted graph may be stored digitally via one or more data structures including but not limited to: graphs, trees, lists, and the like. Alternatively, or in addition, a text file may be generated containing grain centroids 309 that specify centers of mass of respective grains in two or three dimensions, relative positions of centers of mass of distinct grains (i.e., relative vector positions), and/or any characterizable topological/geometric descriptor.

The techniques described herein may further encode 160 the information obtained via one or multiple forms of base characterization 152 into a digital format that can be stored in a non-transitory computer-readable memory. The encoding 160 may take multiple forms and may be stored in multiple formats and/or computer-readable data structures. The encoding techniques 160 may depend on one or more of the following, but not limited to: the specific feature or sets of features being characterized 152, the limitations of the storage medium (e.g., memory capacity or processing speed), the nature of the characterization technique(s) 152 employed, and/or the level of certainty regarding subsequent authentication steps.

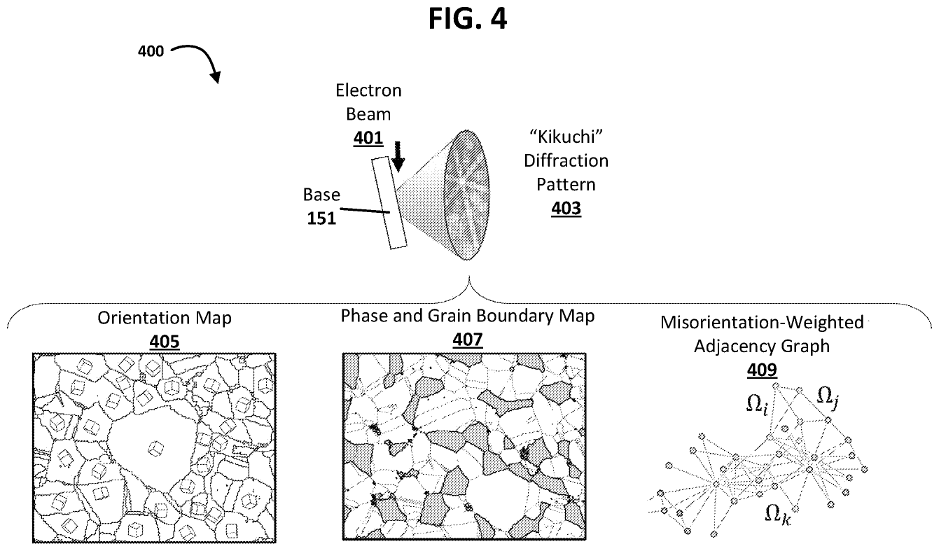

FIG. 4 shows an example process 400 of how electron backscatter diffraction (EBSD) may be used to characterize the interaction of an electron beam 401 with the surface of a suitably-prepared base 151. This interaction may generate a characteristic diffraction pattern including of “Kikuchi bands” 403. A spatially-resolved mapping may then be built up by scanning the electron beam in vertically and horizontally to address a two-dimensional field of view whereby each scanned point in (x,y) space may be associated with a corresponding two-dimensional diffraction pattern. Alternatively, or in addition, the resulting diffraction pattern may be subsequently stored as an image for each position of the base surface characterized.

Alternatively, or in addition, based on aspects of the Kikuchi pattern 403 generated at a specific point (i.e., a position in (x,y) space on the base surface), information regarding the phase at that point may be ascertained. Thus, a spatially-resolved phase and grain boundary map 407 mapping of phase content may be constructed. This mapping may be encoded and stored digitally as an image depicting spatially identifiable discrete phase regions as different colors, with each phase having a color assigned to it. This encoding 160 may be carried out for materials with two or more phases.

Alternatively, or in addition, the resulting Kikuchi bands 403 may be subsequently transformed into “Hough Space.” The Hough transform may convert the Kikuchi bands 403 in (x,y) space into discrete points (ρ, θ) in Hough space using the following relationship, ρ=xcosθ+ysinθ, where (x,y) is the position of the Kikuchi band 403 with respect to a chosen origin and corresponding perpendicular distance at angle θ. The resulting transformed Hough Space image may be encoded and stored as an image for each position of the base surface characterized. Alternatively, or in addition, discrete points in Hough Space that map to corresponding discrete sets of Kikuchi bands 403 may be encoded 160 and stored as pairs of floating-point decimals.

Alternatively, or in addition, the angles between detected Kikuchi bands 403 may be subsequently calculated and compared with a list of interplanar angles corresponding to the crystal structure(s) and corresponding material-specific lattice constants and atomic configurations of the known materials forming the base 151. These interplanar angles may then be used to calculate local crystallographic orientations as described by three discrete rotations in space for each point characterized. Thus, each point, Pᵢ in the characterized area may be encoded and stored digitally as a list of five floating-point numbers as Pᵢ{xᵢ, yᵢ, αᵢ, βᵢ, γᵢ}, where αᵢ, βᵢ, and γᵢ may be the so-called Euler Angles describing a rotation in three-dimensional space about three mutually orthogonal axes chosen based on the characterization apparatus. These three angles, αᵢ, βᵢ, and γᵢ may be further mapped into a color space (e.g., red-green-blue RGB), and may be stored as a two-dimensional image whereby each coordinate point in (x,y) space may be encoded into a corresponding pixel color. The full collection of characterized coordinate points may then be encoded and stored digitally as a color image, where each pixel's color may be mapped to a corresponding local crystallographic orientation in an orientation map 405.

Alternatively, or in addition, a mapping of local crystallographic orientation may be ascertained as previously described. A subset of points in (x,y) space may be identified as locations where orientation changes between neighboring points, i.e., a grain boundary 102. The (x,y) locations of these grain boundaries 102 may then be encoded and stored digitally as two floating-point decimal values, Pᵢ{xᵢ, yᵢ}. Alternatively, or in addition, the (x,y) locations of these phase boundaries 104 may then be encoded and stored digitally as two floating-point decimal values, and one integer value Pᵢ{xᵢ, yᵢ}.

Alternatively, or in addition, the mapping of local crystallographic orientation may implicitly manifest both quantitative orientation information and information regarding the spatial connectivity of grains and their adjacent neighbors. This adjacency information may be encoded as a weighted or unweighted mathematical graph structure where nodes may correspond to grains, edges may correspond to their being connected spatially through a shared grain, with or without weights that may correspond to one or more of: misorientation across the grain boundary 102, length of grain boundary 102 separating respective grains, curvature of grain boundary 102 separating respective grains, and/or a ratio of areas of respective grains. Alternatively, or in addition, the adjacency information may be encoded as an unweighted mathematical graph structure where nodes correspond to grains and/or distinct phase regions, and edges may correspond to their being connected spatially through a shared phase boundary. The weighted and/or unweighted graphs discussed previously may be stored digitally via one or more data structures including but not limited to: graphs (e.g., 409), trees, lists, and the like.

Alternatively, or in addition, the previously-described misorientation between two adjacent grains, across a grain boundary 102 may be calculated. Thus, grain boundary information may be encoded and stored digitally as a list of three floating-point decimals, Pᵢ{xᵢ, yᵢ, Ωᵢ}, where xᵢ, yᵢ may be the locations of grain boundary segments, and Ωᵢ is the magnitude of the misorientation angle across the grain boundary segment separating two grains. The magnitude of the misorientation angle may be mapped to a color space.

Alternatively, or in addition, a series of misorientations may also be determined across a predetermined linear or curved path across the spatially characterized mapping of orientations. The misorientation profile may be subsequently encoded as a continuously changing function of position along the profile path, Ωᵢ(xᵢ, yᵢ), or alternatively as a discrete set of misorientations whose angular magnitude exceeds that of some user-defined threshold. Thus, grain boundary information may be encoded and stored digitally as a function (e.g. a polynomial) describing the profile path, f(xᵢ)=axᵢⁿ+bxᵢⁿ⁻¹+cxᵢⁿ⁻²+ . . . as coefficients of the polynomial, and a function whose values correspond to discrete misorientations Ωᵢ(f(xᵢ)) along the profile.

Alternatively, or in addition, an orientation profile may then be encoded as a continuous changing function of position along the profile path, Ωᵢ(xᵢ, yᵢ), or, alternatively as a discrete set of orientations (one or more Euler Angles) whose angular magnitude exceeds that of some user-defined threshold. Thus, grain boundary information may be encoded and stored digitally as a function (e.g. a polynomial) describing the profile path, f(xᵢ)=axᵢⁿ+bxᵢⁿ⁻¹+cxᵢⁿ⁻²+ . . . as coefficients of the polynomial, and a function whose values correspond to discrete misorientation angular magnitudes Ωᵢ(f(xᵢ)) along the profile.

Alternatively, or in addition, grain boundary information may be encoded and stored digitally as a function whose values correspond to a list of three floating point decimals, {σₖ, σₗ, σₘ} describing the vector axis of rotation (according to the axis-angle description of misorientation) σᵢ(f(xᵢ)) along the profile.

Alternatively, or in addition, the grain boundary information may be encoded and stored digitally as a single set of three floating-point decimals, {σₖ, σₗ, σₘ} describing the net vector {Σₖ, Σₗ, Σₘ} resulting from the addition of all of the axes of rotation and according to the axis-angle description of misorientation) σᵢ(f(xᵢ) encountered along the profile.

Alternatively, or in addition, a mapping of local phase content may be ascertained as previously described. A mapping may implicitly manifest both quantitative orientation information, but also information regarding the spatial connectivity of phases, grains, and their adjacent neighbors. This adjacency information may be encoded as a weighted or unweighted mathematical graph structure where nodes correspond to grains, edges may correspond to their being connected spatially through a shared phase boundary, and weights may correspond to one or a combination of features including one or more of: misorientation across the phase boundary, length of phase boundary separating respective grains, curvature of phase boundary separating respective grains and phases, and/or ratio of areas of respective grain/phase combinations. This weighted and/or unweighted graph may be stored digitally via one or more data structures including but not limited to: graphs, trees, lists, and the like.

Optical microscopy may also be used to image the surface of a suitably prepared base surface. Preferably, the base 151 to be imaged may be suitably prepared in terms of surface flatness, and then also treated with some post-flattening process as previously described to reveal one or more microstructural features. Polarized light, polarized light with sensitive tint, polarized light with differential interference contrast, and/or unpolarized reflective light optical microscopy may be used to image the surface of a base 151, preferably following the suitable preparation steps, such that grain boundaries 102, phase boundaries 104, and/or defects may be optically visible due to their variation in surface topography. The grain boundaries 102, phase boundaries 104, and/or defects may then be encoded 160 and stored digitally as a two-dimensional (pixelated) image 305. A subset of points in (x,y) space may then be identified as locations that are coincident with grain boundaries 102 and/or phase boundaries 104. The (x,y) locations of these grain boundaries 102 and/or phase boundaries 104 may then be encoded 160 and stored digitally as two floating-point decimal values, Pᵢ{xᵢ, yᵢ}.

Alternatively, or in addition, the grain boundaries 102 and phase boundaries 104 may be made optically visible due to their variation in surface topography as well as variations in surface interaction with the visible spectrum based on phase. A mapping may implicitly manifest both quantitative orientation information, but also information regarding the spatial connectivity of phases, grains, and their adjacent neighbors, such as grain boundaries 102 and/or phase boundaries 104 and their relative relationships to one another. This mapping may implicitly manifest information regarding the spatial connectivity of phases, grains, and their adjacent neighbors. This adjacency information may be encoded as a weighted or unweighted mathematical graph structure where nodes correspond to grains and/or distinct phase regions, edges correspond to their being connected spatially through a shared phase boundary with or without weights corresponding to one or a combination of features including but not limited to: length of phase boundary separating respective grains, curvature of phase boundary separating respective grains and phases, and or ratio of areas of respective grain/phase combinations. The weighted and/or unweighted graph may be stored digitally via one or more data structures including but not limited to: graphs, trees, lists, and the like.

One or more of the polarized light, polarized light with sensitive tint, polarized light with differential interference contrast, or unpolarized reflective light optical microscopy may be used to image the surface of a collection of base objects within a single field of view (e.g., multiple powder particles, lengths of wire, flakes, screw with discrete areas of exposed threads, chips, etc.) that have been suitably prepared such that grain boundaries 102 are optically visible. In this instance, the collection of base articles is embedded in a suitable material such that the macroscopic outer geometric boundaries 253 of each individual base article may also be optically distinguished in addition to the microstructure 254 (e.g., grain boundaries 102, phase boundaries 104, defects, etc.) of individual base articles. Thus, the outer macroscopic base article boundaries 253 in addition to other respective microstructural features 254 and grain boundaries 102 may then be encoded 160 and stored digitally as a two-dimensional (pixelated) image 305. This may be considered a nested or hierarchical description.

Scanning electron microscopy may be used to image the surface of a suitably prepared base surface. Preferably, the base 151 to be imaged may be suitably prepared in terms of surface flatness and may also be treated with some post-flattening process as previously described to expose one or more microstructural features 254. The preparation steps may allow visualizing grain boundaries 102, phase boundaries 104, and/or defects due to their variation in surface topography and resulting scattering interactions with incident electron beams. The grain boundaries 102, phase boundaries 104, and/or defects may then be encoded and stored digitally as a two-dimensional (pixelated) image 305. A subset of points in (x,y) space may then be identified as locations that are coincident with grain boundaries 102 and/or phase boundaries 104. The (x,y) locations of these grain boundaries 102 and/or phase boundaries 104 may then be encoded and stored digitally as two floating-point decimal values, Pᵢ{xᵢ, yᵢ}.

Scanning electron microscopy is used to image the surface of a base 151 that has been suitably prepared such that grain boundaries 102 and phase boundaries 104 may be visualized due to their variation in surface topography and resulting scattering interactions with incident electron beams. A mapping may implicitly manifest both quantitative orientation information, but also information regarding the spatial connectivity of phases, grains, and their adjacent neighbors, such as grain boundaries 102 and/or phase boundaries 104 and their relative relationships to one another. This mapping implicitly manifests information regarding the spatial connectivity of phases, grains, and their adjacent neighbors. This adjacency information can be encoded as a weighted or unweighted mathematical graph structure where nodes correspond to grains, edges correspond to their being connected spatially through a shared phase boundary, with or without weights corresponding to one or a combination of features including but not limited to: length of phase boundary separating respective grains, curvature of phase boundary separating respective grains and phases, and or ratio of areas of respective grain/phase combinations. This weighted and/or unweighted graph may be stored digitally via one or more data structures including but not limited to: graphs, trees, lists, and the like.

Scanning electron microscopy may be used to image the surface of a collection of base objects within a single field of view (e.g., multiple powder particles, lengths of wire, flakes, chips, etc.) that have been suitably prepared such that grain boundaries 102 may be visualized due to their variation in surface topography and resulting scattering interactions with incident electron beams. In this example, the collection of base articles may be embedded in a suitable material such that the macroscopic outer geometric boundaries of each individual base article may also be distinguished in addition to the microstructure 100 of individual base articles. Thus, the outer macroscopic base article boundaries 253 in addition to other respective microstructural features 254 and grain boundaries 102 may then be encoded 160 and stored digitally as a two-dimensional (pixelated) image 305.

FIG. 5 shows example techniques 500 for how the base may be packaged and integrated with other distinct physical objects, referred to as a “target” asset. Methods of integration may vary due to geometric, environmental (e.g., temperature, humidity, ph-level, etc.) and/or length scale. Integration may occur in an additive manner or the base 151 and target asset(s) may be one and the same. That is, the characterization 152 and encoding 160 may be carried out on the target asset itself in a “native” manner 505. In this context, native refers to the object serving as the base 151. For example, an article of gold jewelry, itself being crystalline, may have its microstructure 100 be directly characterized and used to authenticate itself (e.g., native integration 505). This may contrast with, for example, a painting or handbag which may require that the base 151 be integrated as an additional component (e.g., integration via surface mount 507). Alternatively, integration may be made by interlacing a metallic or otherwise crystalline component with a woven material 501 or via a component (e.g., a screw) of an assembly of components 503.

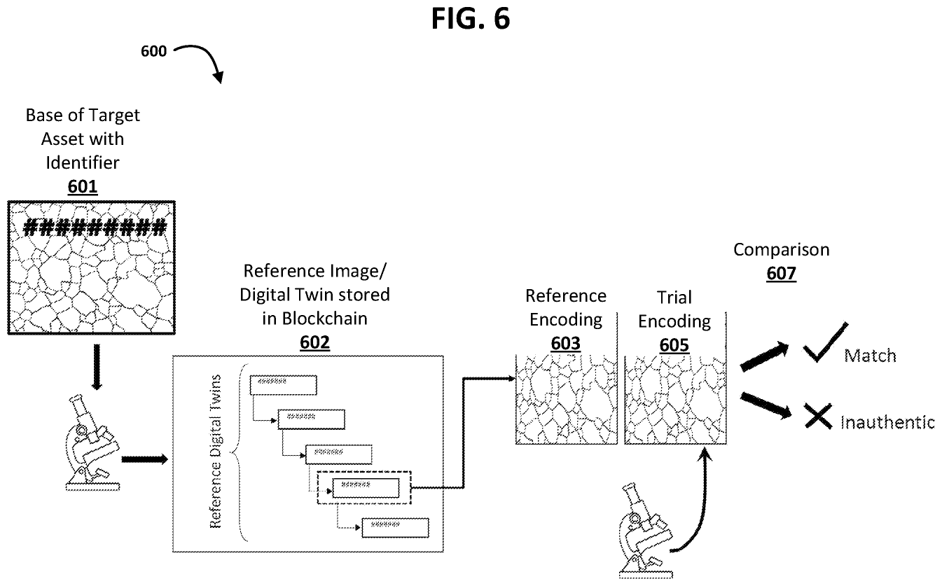

The chosen form(s) of encoding 160 (e.g., image, text-readable data file, serial number, code, binary file, mathematical representation, or other quantitative identification information, etc.) may be stored electronically on any appropriate data format or data structure on a non-transitory electronic storage medium. A form of encoding 160 may be selected based on data storage or cost limitations of the associated memory storage. With any chosen encoding(s) 160, it may be desirable to preserve as much of the unique description of the characterized base 151 as possible. The chosen/stored encoding(s) 160 may serve as a reference encoding 603 for subsequent application of an authentication process as follows referring to FIG. 6.

The chosen encoding 160 may be stored as a reference encoding 603 in a data structure of a non-transitory computer-readable electronic medium (e.g., private computer server, web server, distributed electronic ledger such as a blockchain 602, etc.). Alternatively, or in addition, the chosen reference encoding 603 may be stored externally in a non-transitory computer-readable medium as previously described, and the data structure specifies a link or storage location of an external non-transitory computer-readable medium. Later, the base 151, having retained its surface characteristics, may be re-characterized 152 to generate a new encoding 160. As used herein, this new encoding 160 is termed the trial encoding 605. The trial encoding 605 may be generated using the characterization 152 of a spatial region of a base 151 that is at least partially spatially coincident with that of the spatial region on which the reference encoding 603 is based. The trial encoding 605 or features thereof can then be compared 607 to the reference encoding 603 and an assessment may be made as to whether the reference encoding 603 was generated from the same base 151. As explained previously, the encoding 603 may be implemented as an image, text-readable data file, serial number, code, binary file, mathematical representation, or other quantitative identification information. For purposes of discussion with respect to the example of FIG. 6, the encoding 160 retrieved from the blockchain 602 is implemented as an image 603. Due to its uniqueness, only the physical base 151 that generated the original reference characterization 152 and encoding 160 may be used to generate a corresponding matching encoding 160.

The assessment of whether a trial encoding 605 matches a reference encoding 603 may be carried out in a fully automated manner, partially automated (“human-in-the-loop”) or fully manually by a human(s).

The fully automated approach may rely on the use of software tools such as computer vision, machine learning, neural networks, image comparing algorithms, and the like. The fully automated approach may take the reference 603 and trial encodings 605 as input, compares them in step 607, and, based on a set of predetermined metrics, may provide a match/no-match assessment with or without an accompanying level of confidence (e.g., a score) for the decision.

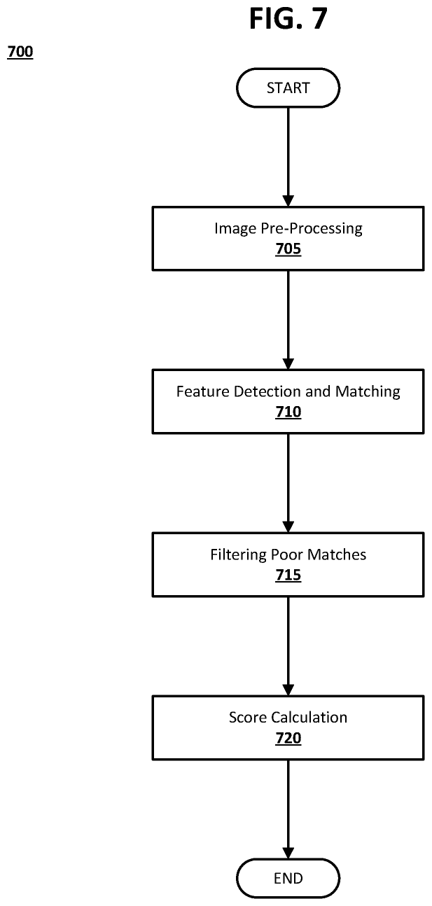

FIG. 7 shows an example fully automated image matching algorithm 700 that may be performed in the context of comparison 607 previously described. The fully automated image matching algorithm 700 may include the steps of pre-processing the input images 705, feature detection and matching 710, filtering out poor matches 715, and calculating a score 720.

During the image pre-processing 705, the input images may be converted to grayscale as needed and the contrast may be balanced as closely as practical. Features may be detected in an automated fashion in step 710. The features may then be automatically matched using an approach that may consider relative distance regardless of scale or absolute location. In general feature matches may be ranked based on the strength of correspondence between the features (e.g., exact match, close match, poor match, etc.). Matches having poor correspondence may be filtered out and removed from consideration in step 715. In step 720, a score may be calculated using one or more predetermined scale factors and based on the quantity of feature matches and the associated feature match rank.

The partially automated solution may also leverage the same or similar software tools, though in this case, instead of providing a binary yes/no assessment, it may provide a recommendation with or without an accompanying confidence level. In contrast, the actual decision of whether a match exists (i.e., 607) may be left to a human to make the final assessment.

The fully manual approach to authentication may simply be based on a side-by-side comparison of the reference and trial encodings 605 (e.g., an image) by a human making the assessment.

The base 151 may be used to provide an assessment of authenticity for many different use cases. A base 151 may be used to authenticate itself, or, alternatively, a separate/distinct physical and/or digital item or asset. Self-authentication or “native” authentication may rely on characterization of the base itself. A physical object, which may be termed a target asset, may serve as its own base 151 if it is composed of crystalline material. A simple example of this may be jewelry made from precious metals (e.g., gold, silver, platinum, etc.); all of which are crystalline.

If authenticating a separate target asset, the base 151 may be physically integrated in an additive manner using several different approaches (see e.g., FIG. 5). Due to the information density contained in very small regions (<0.5 mm²), the base 151 may be integrated surreptitiously, or in several convenient form factors such as surface mounted, woven, as part of an assembly component (e.g., a screw or bolt head).

Tamper-proof or tamper-evident techniques may be directly utilized for robust operation. Furthermore, scratch/damage resistant coatings and coverings may be employed to ensure the persistence of a high-quality surface for maintaining the ability to characterize 152, encode 160, and authenticate the base 151 over long periods of time (e.g., years). Alternatively, the base article 151 need not necessarily be physically integrated with the target asset. The base 151 could be stored separately and securely from the item, and only accessed when authentication is carried out. Damage to the base 151 or the characterized portion thereof may result in the loss of the ability to authenticate the base 151 and/or associated target asset.

To establish and maintain a link between a base 151 and corresponding target asset to be authenticated, a serialization process may be implemented. One such approach could utilize laser marking or engraving a serial number or other identifier directly in to the surface of the base 151 of the target asset 601 as previously described, which would also be visible upon microstructural characterization 152. The same serial number/identifier may also be incorporated on some portion of the target asset. The serial number/identifier may be generated based on encoding 160 the characterized base 151 and scribed in the same field of view and/or perimeter region as the microstructure 100 that gave rise to it. In other words, the scribed serial number/identifier may assist in locating the image to capture on the target asset by implicitly specifying a minimum area of the base 151 of the target asset that may generally correspond to the region of the serial number/identifier. In this way, a reference image 603 of the microstructure, which may be used to compare 607 with a trial image 605 of the target asset and authenticate the target asset, may also show the laser-scribed serial number/identifier. Alternatively, or in addition, the serial number/identifier scribed on the base 151 and/or target asset may not be the result of encoding 160 the characterized base 151 and instead, generated using some independent process.

The term “blockchain” as used herein refers to a distributed ledger that records transactions between multiple computing systems in a verifiable and permanent manner. Accordingly, a blockchain is considered an immutable ledger. Transactions between computing systems may be recorded to a blockchain in the form of a growing linked list of “blocks.” A subject block, once added to the blockchain, cannot be altered retroactively without altering all the subsequently-added blocks.

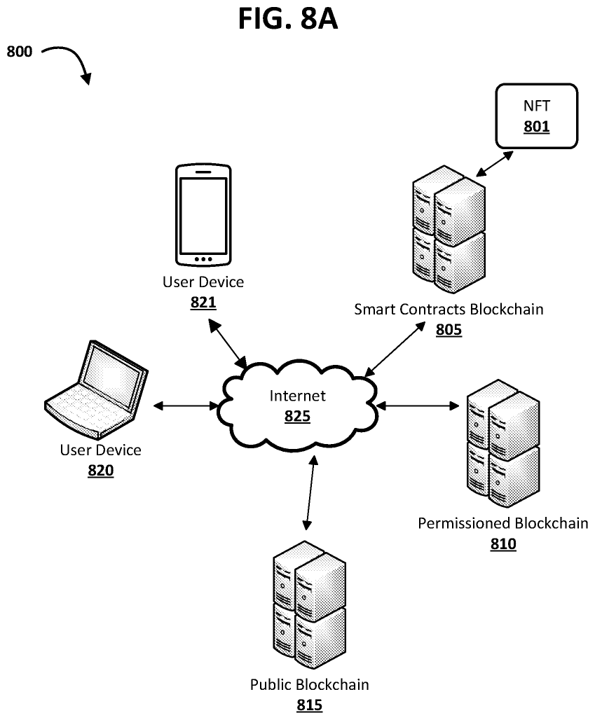

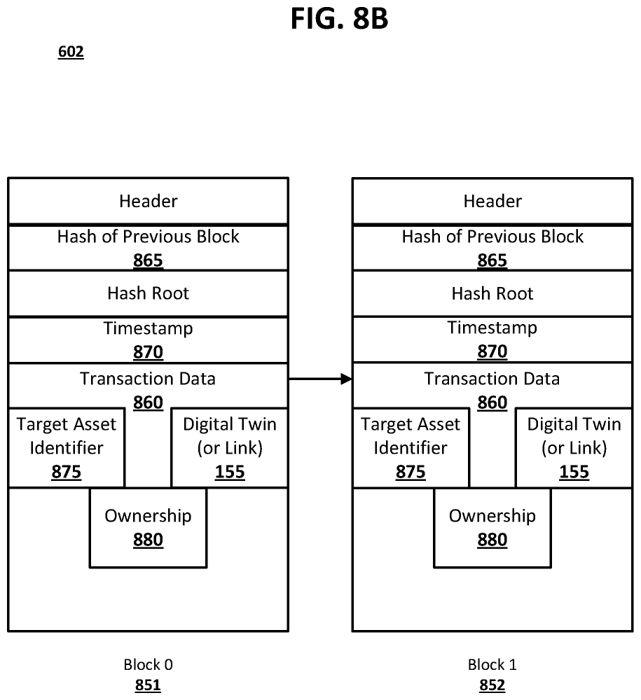

FIG. 8A shows an example block diagram overview of a computing network 800 in accordance with the present subject matter including user devices 820/821, an example network 825, a smart contracts blockchain 805, a permissioned blockchain 810, and a public blockchain 815. The previously-discussed digital twin 155 may be stored on any of the illustrated blockchains 805/810/815. As shown in FIG. 8B, a block 851/852 of an example blockchain 602 may contain a link 855 to a digital twin 155 that is stored on one or more computer systems. Alternatively, or in addition, where the digital twin 155 is encoded in a non-image format or other relatively small-sized digital format, such as a serial number, text file, series of numbers, or the like, the digital twin 155 may be stored on the blockchain 602 within a transaction data portion 860. The block 851/852 of the blockchain 602 may also include contain a cryptographic hash of the previous block 865, a timestamp 870, and the aforementioned transaction data portion 860 including a target asset-specific identifier 875, ownership information 880, and the like. The target asset-specific identifier 875 may uniquely identify a target asset such that no two target assets may share a same target asset-specific identifier 875. In this way, the block 851/852 of the blockchain 602 may associate the digital twin 155, which is derived from the characterized base 151, with the target asset. When the digital twin 155 is stored on a block 851/852 of the blockchain 602 or linked to another data storage location via the block 851/852 of the blockchain 602, the block 851/852 may be considered a non-fungible token (NFT) 801, as will be subsequently described.

A blockchain may be managed autonomously using a peer-to-peer network and a distributed timestamping server. In some decentralized blockchains, every node in the decentralized system may store a copy of the blockchain 805/810/815. Transactions may be broadcast over the computer network 825 and data security may be maintained through massive database replication and computational trust.

Blockchains may be publicly accessible in a manner that may be referred to as permissionless. In a permissionless (public) blockchain 815, any computing system (e.g., 820, 821) may choose to run a node for the blockchain and participate in transaction verifications (via a mining mechanism), as well as create smart contracts on the network. In an example, a blockchain network 800 may be permissionless and employ a crypto-economic model, which is driven by proof-of-work consensus mechanisms, that incentivizes operating network nodes. In these example frameworks, network participants may be rewarded for their contributions through issuance of cryptographic tokens, which may be referred to as crypto coins or cryptocurrency.

A permissioned blockchain 810 may be a closed computing system in which each participant is well defined. This type of blockchain may be designed to allow an organization or a consortium of organizations to efficiently exchange information and record transactions. In a permissioned blockchain 810, only preapproved entities may run the nodes that validate transaction blocks and execute smart contracts on the blockchain.

In the context of both permissioned 810 and permissionless 815 blockchains, the term smart contract may refer to software programs that execute on a blockchain. While a standard legal contract may outline the legally-enforceable terms of a relationship, a smart contract enforces a set of rules using cryptographic code. Smart contracts may be developed as high-level programming abstractions that can be distilled to bytecode that can be deployed to a blockchain for execution by computing systems 820/821 using a virtual machine. Once a smart contract is written to a blockchain, the code of the smart contract may as a programmatically-defined autonomous agent with its own persistent variables that executes within one or more computing systems participating on the blockchain network 800. The smart contract may be responsive when referenced by a message and/or transaction. Smart contracts may execute by leveraging the code of other smart contracts in a manner similar to calling upon a software library.

The link 855 to the image of the characterized base 151, when incorporated into the cryptographic block 851/852 of a smart contracts blockchain 805, may be considered an NFT 801. Alternatively, a subsequent derivation of the characterized base 151, such as another image, serial number, numeric pattern, or the like, as previously described, whether stored directly in the block of the blockchain 805 or linked to another data storage location via the block 851/852 of the blockchain 805, may also be considered an NFT 801. Possession of the NFT 801 may reflect the ownership of the associated target asset, which may be identified by the target asset-specific identifier contained in the block 851/852. The NFT 801 may be non-interchangeable as each may include a unique serial number and may incorporate programmatically-defined digital rights management. For example, the smart contract blockchain 805 may define an interface that enables the NFT 801 to be managed, owned, and/or traded by its owner. Examples of such interfaces include ERC-721, ERC-1155, and the like. In some example embodiments, the NFTs 801 may be “minted” (i.e., created) such that independent authentication of the entity that minted the NFT 801 is possible. The NFT 801 may be securely stored in “wallet” applications that allow in one or more computing systems of the user that owns the NFT 801.

The smart contracts defining NFTs 801 that may be minted may specify fee distribution obligations with respect to specific types of transactions involving NFTs 801. For instance, the sale of an NFT 801 may result in one or more residual processing fee transactions that may be recorded in the blockchain 805 including a payment to the creator that minted the NFT 801. The authenticity of an NFT 801 may be verified independently of the entity that minted the NFT 801 by auditing transaction records associated with the NFT 801 within the blockchain 805 to confirm consistency with the smart contract. For example, the presence of transactions reflecting payments that the smart contract indicates should have occurred upon transfers of the NFT 801 and the associated target asset may be relied upon to verify the authenticity of the NFT 801. It should be appreciated that the manner in which one or more transactions written to the blockchain 805 can be utilized to verify the authenticity of the NFT 801 is largely dependent upon the requirements of a given application.

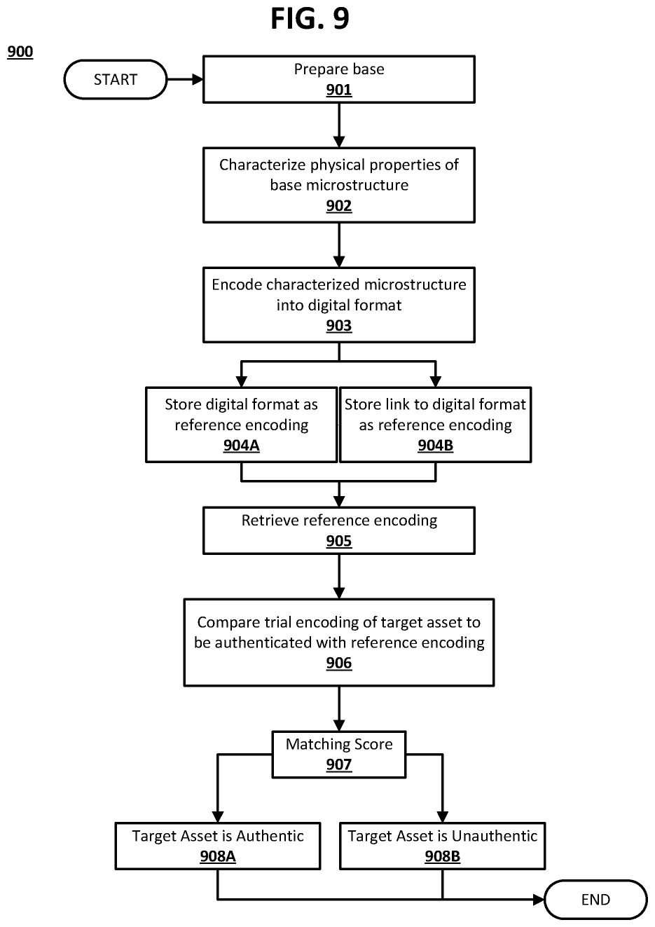

FIG. 9 illustrates a process 900 for authenticating a target asset in accordance with the present subject matter. In step 901, the base 151 may be prepared as previously described with respect to FIGS. 2A and 2B. In step 902, the base microstructure 100 may be characterized 152 using any of the various techniques discussed with respect to FIG. 3. In step 903, the characterized microstructure 100 may be encoded 160 into a digital format as discussed with respect to FIG. 4. In steps 904A/904B, the digital format may be stored itself on a server 904A, such as a blockchain 602, or as a link 904B, such as in the case of an NFT 801. At this point, the stored digital format of the encoding may be referred to as the reference encoding 603 for an associated asset. In step 905, the reference encoding 603 may be retrieved for authenticating the target asset at a later time. A trial encoding 605 of a target asset may be compared with the reference encoding 603 in 906 as previously described with respect to FIG. 7. The matching score between the reference encoding 603 and the trial encoding 605 may be evaluated in step 907 to assess the likelihood of whether the target asset is authentic (908A) or unauthentic (908B).

The steps illustrated in the flow diagrams may include additional, different, or fewer operations than illustrated. The operations illustrated may be performed in an order different than illustrated.

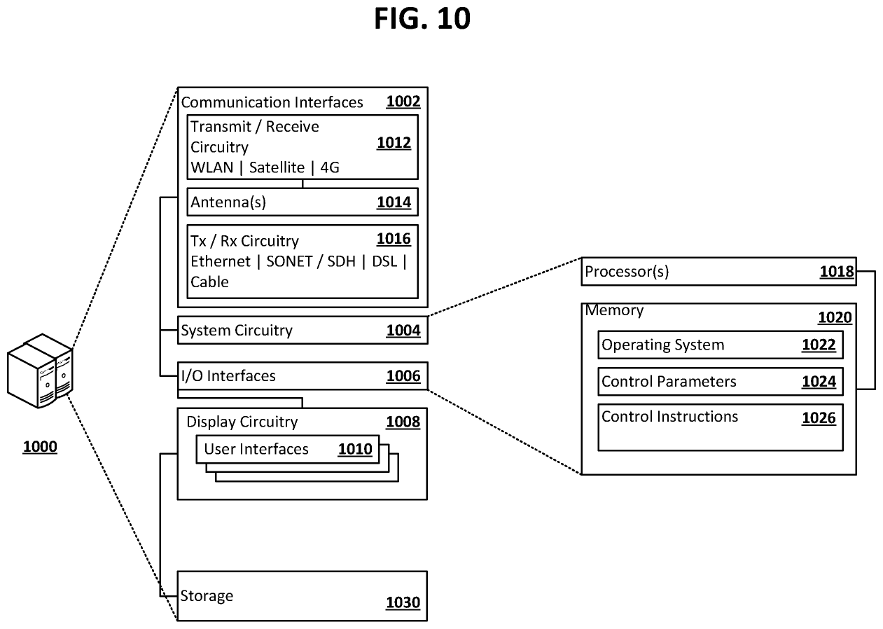

FIG. 10 illustrates an example architecture of a computing device 1000 on which the various computing components of the system described above. The computing device 1000 may include communication interfaces 1002, system circuitry 1004, input/output (I/O) interface circuitry 1006, and display circuitry 1008. The graphical user interfaces (GUIs) 1010 displayed by the display circuitry 1008 may be used to receive user commands/input and to display various outputs. The GUIs 1010 may be displayed locally using the display circuitry 1008, or for remote visualization, e.g., as HTML, JavaScript, audio, and video output for a web browser running on a local or remote machine.

The GUIs 1010 and the I/O interface circuitry 1006 may include touch sensitive displays, voice or facial recognition inputs, buttons, switches, speakers, and other user interface elements. Additional examples of the I/O interface circuitry 1006 includes microphones, video and still image cameras, headset and microphone input/output jacks, Universal Serial Bus (USB) connectors, memory card slots, and other types of inputs. The I/O interface circuitry 1006 may further include magnetic or optical media interfaces (e.g., a CDROM or DVD drive), serial and parallel bus interfaces, and keyboard and mouse interfaces.

The communication interfaces 1002 may include wireless transmitters and receivers (“transceivers”) 1012 and any antennas 1014 used by the transmit and receive circuitry of the transceivers 1012. The transceivers 1012 and antennas 1014 may support WiFi network communications, for instance, under any version of IEEE 802.11, e.g., 802.11n or 802.11ac, or other wireless protocols such as Bluetooth, Wi-Fi, WLAN, cellular (4G, LTE/A). The communication interfaces 1002 may also include serial interfaces, such as universal serial bus (USB), serial ATA, IEEE 1394, lighting port, I²C, slimBus, or other serial interfaces. The communication interfaces 1002 may also include wireline transceivers 1016 to support wired communication protocols. The wireline transceivers 1016 may provide physical layer interfaces for any of a wide range of communication protocols, such as any type of Ethernet, Gigabit Ethernet, optical networking protocols, data over cable service interface specification (DOCSIS), digital subscriber line (DSL), Synchronous Optical Network (SONET), or other protocol.

The system circuitry 1004 may include any combination of hardware, software, firmware, APIs, and/or other circuitry. The system circuitry 1004 may be implemented, for example, with one or more systems on a chip (SoC), application specific integrated circuits (ASIC), microprocessors, discrete analog and digital circuits, and other circuitry. The system circuitry 1004 may implement any desired functionality of the disclosed system and its various components. As just one example, the system circuitry 1004 may include one or more instruction processor 1018 and memory 1020.

The memory 1020 may be implemented as a non-transitory memory circuit and may store, for example, control instructions 1022 for implementing the various functions described above, as well as an operating system 1021. In one implementation, the processor 1018 executes the control instructions 1022 and the operating system 1021 to carry out any desired functionality of the adaptive federated learning process above.

The computing device 1000 may further include various data sources 1030, or may be in communication with external data sources. Each of the databases that are included in the data sources 1030 may be accessed by the various component of the disclosed system and its components.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein may be employed.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

Many other modifications of the implementations above may be made to adapt a particular situation or material to the teachings without departing from the scope of the current disclosure. Therefore, it is intended that the present methods and systems not be limited to the particular embodiments disclosed, but that the disclosed methods and systems include all embodiments falling within the scope of the appended claims.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general-purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk, or any other device capable of storing electronic information. The memory may store instructions adapted to be executed by the processor to perform the techniques according to embodiments of the disclosed subject matter.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:

A first aspect relates to a method of characterizing a microstructure of a base, comprising: capturing the microstructure of the base using a microscopy technique, wherein the characterized microstructure includes one or more features comprising: phase boundaries, grain boundaries, amorphous inclusions, crystalline inclusions, precipitates, compounds, impurities, slip traces, slip bands, slip lines, persistent slip bands, defect structures, dislocation, stacking faults, or cold work; encoding the one or more features into an n-dimensional digital format; and storing the n-dimensional digital format in a non-transitory computer-readable memory.

A second aspect relates to the method of aspect 1, wherein the microscopy technique is reflected light optical microscopy.

A third aspect relates to the method of any preceding aspect, wherein the microscopy technique is bright-field optical microscopy.

A fourth aspect relates to the method of any preceding aspect, wherein the microscopy technique is dark-field optical microscopy.

A fifth aspect relates to the method of any preceding aspect, wherein the microscopy technique is fluorescence microscopy.

A sixth aspect relates to the method of any preceding aspect, wherein the microscopy technique is polarized-light microscopy.

A seventh aspect relates to the method of any preceding aspect, wherein the microscopy technique is differential interference contrast microscopy.

An eighth aspect relates to the method of any preceding aspect, wherein the microscopy technique is polarized-light microscopy with sensitive tint.

A ninth aspect relates to the method of any preceding aspect, wherein the microscopy technique is x-ray diffraction.

A tenth aspect relates to the method of any preceding aspect, wherein the microscopy technique is raman spectroscopy.

An eleventh aspect relates to the method of any preceding aspect, wherein the microscopy technique is infrared spectroscopy.

A twelfth aspect relates to the method of any preceding aspect, wherein the microscopy technique is ultraviolet spectroscopy.

A thirteenth aspect relates to the method of any preceding aspect, wherein the microscopy technique is scanning electron microscopy.

A fourteenth aspect relates to the method of any preceding aspect, wherein the microscopy technique is electron backscatter diffraction (EBSD).

A fifteenth aspect relates to the method of any preceding aspect, wherein the microscopy technique is transmission electron microscopy.

A sixteenth aspect relates to the method of any preceding aspect, wherein the microscopy technique is selected area diffraction.

A seventeenth aspect relates to the method of any preceding aspect, wherein the microscopy technique is electron dispersive x-ray spectroscopy.

An eighteenth aspect relates to the method of any preceding aspect, wherein the microscopy technique is x-ray photoelectron spectroscopy.

A nineteenth aspect relates to the method of any preceding aspect, wherein the encoding further comprises: generating a digital image of the characterized microstructure, wherein the generated digital image is the n-dimensional digital format.

A twentieth aspect relates to the method of any preceding aspect, wherein the encoding further comprises: determining a two-dimensional position of a grain boundary between grains, and mapping the two-dimensional position of the grain boundary to a two-dimensional coordinate of a pixel.

A twenty-first aspect relates to the method of any preceding aspect, wherein the base comprises a scannable UPC or QR code.

A twenty-second aspect relates to the method of any preceding aspect, further comprising: irradiating the base using a laser to polish the base.

A twenty-third aspect relates to the method of any preceding aspect, further comprising: mechanically polishing the base.

A twenty-fourth aspect relates to the method of any preceding aspect, further comprising: applying a film to the base to obscure the microstructure.

A twenty-fifth aspect relates to the method of any preceding aspect, further comprising: appending a block to a blockchain containing the n-dimensional digital format or containing a link to the non-transitory computer-readable memory.

A twenty-sixth aspect relates to a method of authenticating a physical object, comprising: identifying a base of the physical object; characterizing the base; retrieving a digital format of a reference base from a data structure, wherein the data structure further comprises a target asset identifier uniquely identifying a target asset; comparing the digital format of the reference base with the characterized base; and authenticating the physical object as being the target asset based on the comparing and the target asset identifier.

A twenty-seventh aspect relates to the method of aspect 26, wherein characterizing the base further comprises: imaging the base using microscopy equipment.

A twenty-eighth aspect relates to the method of aspects 26 or 27, wherein the digital format of the reference base comprises Kikuchi bands.

A twenty-ninth aspect relates to the method of aspects 26-28, wherein the digital format of the reference base comprises a serial number.

A thirtieth aspect relates to the method of aspects 26-29, wherein the digital format of the reference base comprises a graph generated based on spatial relationships between grains and adjacent grains forming a microstructure of the reference base.

A thirty-first aspect relates to the method of aspects 26-30, wherein characterizing the base further comprises: generating a digital image of a microstructure of the base, wherein the characterized base is the digital image of the microstructure of the base.

A thirty-second aspect relates to the method of aspects 26-31, wherein the characterized base is encoded as an n-dimensional digital format identifying locations coincident with grain boundaries and/or phase boundaries of a microstructure of the base.

A thirty-third aspect relates to the method of aspects 26-32, wherein the data structure is a non-fungible token (NFT).

A thirty-fourth aspect relates to the method of aspects 26-33, wherein the data structure is a database.

A thirty-fifth aspect relates to the method of aspects 26-34, wherein the data structure is a block of a blockchain network.

A thirty-sixth aspect relates to the method of aspects 26-35, wherein the block specifies a location of an external non-transitory computer-readable storage medium storing the digital format of the reference base.

A thirty-seventh aspect relates to the method of aspects 26-36, wherein the characterized base comprises a portion of the physical object.

A thirty-eighth aspect relates to the method of aspects 26-36, wherein the characterized base is disposed on a functional component of the physical object.

In addition to the features mentioned in each of the independent aspects enumerated above, some examples may show, alone or in combination, the optional features mentioned in the dependent aspects and/or as disclosed in the description above and shown in the figures.

1. A method of authenticating a physical object, comprising:
identifying a base of the physical object;
characterizing the base;
retrieving a digital format of a reference base from a data structure, wherein the data structure further comprises a target asset identifier uniquely identifying a target asset;
comparing the digital format of the reference base with the characterized base; and
authenticating the physical object as being the target asset based on the comparing and the target asset identifier.

2. The method of claim 1, wherein characterizing the base further comprises:
imaging the base using microscopy equipment.

3. The method of claim 1, wherein
the digital format of the reference base comprises Kikuchi bands or any crystallographic orientation information derived therefrom.

4. The method of claim 1, wherein
the digital format of the reference base comprises a serial number.

5. The method of claim 1, wherein
the digital format of the reference base comprises a graph generated based on spatial relationships between grains and adjacent grains forming a microstructure of the reference base.

6. The method of claim 1, wherein characterizing the base further comprises:
generating a digital image of a microstructure of the base, wherein the characterized base is the digital image of the microstructure of the base.

7. The method of claim 1, wherein
the characterized base is encoded as an n-dimensional digital format identifying locations coincident with grain boundaries and/or phase boundaries of a microstructure of the base.

8. (canceled)

9. The method of claim 1, wherein
the data structure is a database.

10-11. (canceled)

12. The method of claim 1, wherein
the characterized base comprises a portion of the physical object.

13. (canceled)

14. A method of characterizing a microstructure of a base, comprising:
characterizing the microstructure of the base using a microscopy technique, wherein the characterized microstructure includes one or more features comprising:
crystallographic orientation, phase boundaries, grain boundaries, amorphous inclusions, crystalline inclusions, precipitates, compounds, impurities, slip traces, slip bands, slip lines, persistent slip bands, defect structures, dislocation, stacking faults, or cold work;
encoding the one or more features into an n-dimensional digital format; and
storing the n-dimensional digital format in a non-transitory computer-readable memory.

15. The method of claim 14, wherein the microscopy technique is selected from reflected light optical microscopy, bright-field optical microscopy, and dark-field optical microscopy.

16-18. (canceled)

19. The method of claim 14, wherein the microscopy technique is polarized-light microscopy.

20. The method of claim 14, wherein the microscopy technique is differential interference contrast microscopy.

21. The method of claim 14, wherein the microscopy technique is polarized-light microscopy with sensitive tint.

22-25. (canceled)

26. The method of claim 14, wherein the microscopy technique is scanning electron microscopy.

27. The method of claim 14, wherein the microscopy technique is electron backscatter diffraction (EBSD).

28-31. (canceled)

32. The method of claim 14, wherein the encoding further comprises:
generating a digital image of the characterized microstructure, wherein the generated digital image is the n-dimensional digital format.

33. The method of claim 14, wherein the encoding further comprises:
determining a two-dimensional position of a grain boundary between grains, and
mapping the two-dimensional position of the grain boundary to a two-dimensional coordinate of a pixel.

34. (canceled)

35. The method of claim 14, further comprising:
irradiating the base using a laser to polish the base.

36. The method of claim 14, further comprising:
mechanically polishing the base.

37. The method of claim 14, further comprising:
applying a film to the base to obscure the microstructure.

38. (canceled)
